(19) United States
(12) Patent Application Publication
(10) Pub. No.: US 2015/0180525 A1
(43) Pub. Date: Jun. 25, 2015

(54) COVER CASE AND ELECTRONIC SYSTEM

(71) Applicant: HTC Corporation, Taoyuan City (TW)

(72) Inventor: Ming-Yu CHEN, Taoyuan City (TW)

(73) Assignee: HTC Corporation, Taoyuan City (TW)

(21) Appl. No.: 14/137,053

(22) Filed: Dec. 20, 2013

(51) Int. Cl. H04B 1/3888

(52) U.S. Cl. CPC H04B 1/3888

(57) ABSTRACT

A cover case suitable for an electronic device and being detachably attached to the electronic device includes an antenna module, a controller, a display unit, an energy storage unit and a charging circuit. The antenna module receives a wireless signal from the electronic device. The wireless signal includes display data. The controller is coupled to the antenna module and obtains the display data according to the wireless signal. The display unit is coupled to the controller for displaying the display data. The energy storage unit is coupled to the controller and the display unit. The charging circuit is coupled to the antenna module and the energy storage unit. The charging circuit converts the wireless signal into electricity via the antenna module and stores the electricity in the energy storage unit.

### BACKGROUND OF THE INVENTION

1. Field of the Invention

The application relates to a cover case, and more particularly to a cover case having wireless communication and information display functionalities.

2. Description of the Related Art

Nowadays, most users are getting used to apply a cover or a case (also called cover case) on their portable electronic devices, such as cellular phones, tablets, personal digital assistants, etc, so as to prevent the portable electronic devices from being damaged and to show their personal style.

Since the cover cases have become an important accessory for portable electronic devices, how to enhance the functionality of cover cases is an issue worthy of consideration in the communications industry.

### BRIEF SUMMARY OF THE INVENTION

A cover case and electronic system are provided. An exemplary embodiment of a cover case suitable for an electronic device and being detachably attached to the electronic device comprises an antenna module, a controller, a display unit, an energy storage unit and a charging circuit. The antenna module receives a wireless signal from the electronic device. The wireless signal comprises display data. The controller is coupled to the antenna module and obtains the display data according to the wireless signal. The display unit is coupled to the controller for displaying the display data. The energy storage unit is coupled to the controller and the display unit. The charging circuit is coupled to the antenna module and the energy storage unit. The charging circuit converts the wireless signal into electricity via the antenna module and stores the electricity in the energy storage unit.

An exemplary embodiment of an electronic system comprises an electronic device and a cover case. The electronic device comprises a processing unit, a first antenna module, a first controller and a first display unit. The processing unit generates display data. The first antenna module generates a first wireless signal according to a control signal. The first wireless signal comprises the display data. The first controller is coupled to the first antenna module and the processing unit. The first controller generates the control signal according to the display data. The first display unit is coupled to the processing unit. The cover case is detachably attached to the electronic device and comprises a second antenna module, a second controller, a second display unit, an energy storage unit, and a charging circuit. The second antenna module receives the first wireless signal generated by the electronic device. The second controller is coupled to the second antenna module. The second controller obtains the display data according to the received first wireless signal. The second display unit is coupled to the second controller for displaying the display data. The energy storage unit is coupled to the second controller and the second display unit. The charging circuit is coupled to the second antenna module and the energy storage unit. The charging circuit converts the first wireless signal into electricity via the second antenna module and stores the electricity in the energy storage unit.

A detailed description is given in the following embodiments with reference to the accompanying drawings.

### BRIEF DESCRIPTION OF DRAWINGS

The application may be more fully understood by reading the subsequent detailed description and examples with references made to the accompanying drawings, wherein:

FIG. 1 shows a top view of a cover case according to an embodiment of the application;

FIG. 2 shows a side view of a cover case according to an embodiment of the application;

FIG. 3 shows a side view of an electronic device according to an embodiment of the application;

FIG. 4 shows a block diagram of a cover case according to an embodiment of the application; and

FIG. 5 shows a block diagram of an electronic device according to an embodiment of the application.

### DETAILED DESCRIPTION OF THE INVENTION

The following description is of the best-contemplated mode of carrying out the application. This description is made for the purpose of illustrating the general principles of the application and should not be taken in a limiting sense. The scope of the application is best determined by reference to the appended claims.

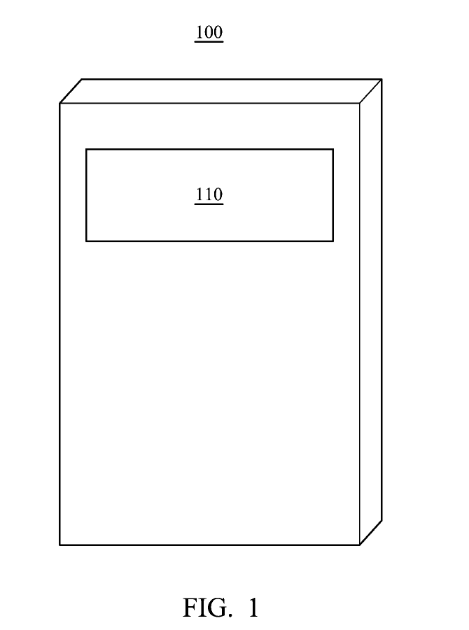

FIG. 1 shows a top view of a cover case according to an embodiment of the application. According to an embodiment of the application, the cover case 100 may comprise both the functionalities of wireless communication and information display. For example, the cover case 100 may comprise a wireless communication module (not shown) and a display unit 110. The wireless communication module may provide wireless communication services in compliance with a predetermined wireless communication protocol. The display unit 110 may be a liquid crystal display device, a light-emitting diode display device, or a bi-stable display device, such as an electronic paper, interferometric modulator (IMOD) display device, or others, where the low power consumption bi-stable display device is preferable.

The cover case 100 may be suitable for an electronic device, and may be detachably attached to the electronic device. The electronic device may be a portable electronic device, such as a tablet computer, a cellular phone, a personal digital assistance, or others. According to an embodiment of the application, the cover case may cover at least one side of the electronic device so as to prevent the portable electronic device from being damaged due to dropping or collision. Therefore, when the cover case 100 attaches to the electronic device, the cover case 100 may be connected to at least one side of the electronic device. According to an embodiment of the application, when an event about which the electronic device has to notify the user has occurred, the electronic device may transmit the display data regarding the event to the cover case 100, such that the display data of the electronic device may further be displayed on the display unit 110 of the cover case 100. Note that, in the embodiment of the application, the display unit 110 may be configured in any side and any position of the cover case 100. Therefore, the design shown in FIG. 1 is merely one exemplary implementation of the application, and the application should not be limited thereto.

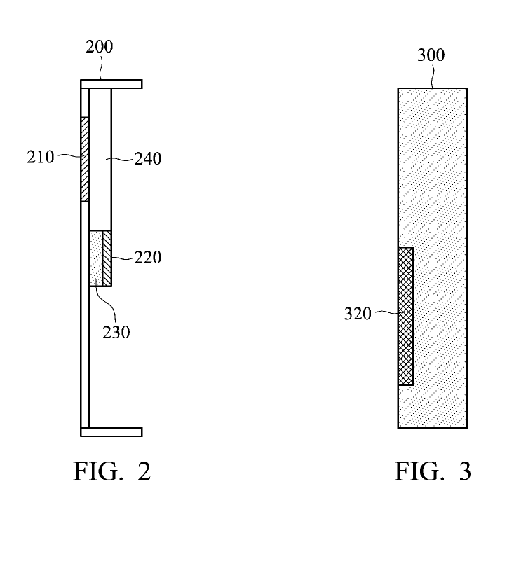

FIG. 2 shows a side view of a cover case according to an embodiment of the application. FIG. 3 shows a side view of an electronic device according to an embodiment of the application. According to an embodiment of the application, as shown in FIG. 2, the cover case 200 may comprise at least three side walls and a recess defined by the side walls. The electronic device may be configured in the recess, and the display unit of the cover case 200 may be configured in any side wall of the cover case 200. The size and shape of the cover case 200 may be designed to match the size and shape of the electronic device 300, such that when the cover case 200 attaches to the electronic device 300, the cover case 200 may connect to or cover at least one side of the electronic device 300, so as to prevent the electronic device 300 from being damaged due to dropping or collision. In addition, according to an embodiment of the application, the electronic device 300 may comprise a surface, a side wall and a back. The side wall may be connected to the surface and the back and comprise four corners. The display unit of the electronic device 300 may be configured on the surface, and the cover case 200 may attach to the back and the four corners of the electronic device 300.

According to an embodiment of the application, when the cover case 200 attaches to the electronic device 300, an electronic system may be formed by the cover case 200 and the electronic device 300, and the cover case 200 and the electronic device 300 may communicate with each other in the electronic system in compliance with a predetermined wireless communication protocol. For example, the cover case 200 may comprise at least one display unit 210 and a wireless communication module 220. The electronic device 300 may at least comprise a wireless communication module 320, wherein the cover case 200 and the electronic device 300 may communicate with each other in the electronic system in compliance with a predetermined wireless communication protocol via the wireless communication modules 220 and 320.

According to an embodiment of the application, when the cover case 200 attaches to the electronic device 300, the cover case 200 may register with the electronic device 300 via the wireless communication module 220, such that the electronic device 300 may identify the cover case 200. After registration, the electronic device 300 may change a software setting such that when an event about which the electronic device 300 has to notify the user has occurred, the electronic device 300 may generate and transmit at least one wireless signal comprising the display data to the cover case 200. The event that the electronic device 300 has to notify the user may comprise, but is not limited to, a missed call notification, an unread message notification, battery volume, current time, a calendar reminder notification, a system update notification, or others.

Note that in the conventional design, for example, when a user has missed an incoming call, or is unable to read a new message in time, the electronic device (for example, a cellular phone) may actively show the missed call or the unread message on the screen of the electronic device to notify the user. When detecting that the user has not further operated the electronic device for a predefined time, the electronic device may enter an idle mode or a sleep mode to reduce the power consumption. When entering the idle mode or the sleep mode, the monitor of the electronic device may be turned off and not emit light, and a portion of hardware devices may be disabled. Therefore, it is hard for the user to read the missed call or the unread message notification without waking up the electronic device.

However, in the embodiment of the application, when an event about which the electronic device 300 has to notify the user has occurred, the electronic device 300 does not directly enter the idle mode or sleep mode after displaying the notification of the event on the display unit of the electronic device 300, but generates and transmits at least one wireless signal comprising the display data to the cover case 200 and then returns to the idle mode or sleep mode for reducing the power consumption. In this manner, the display data may be displayed in a low power consumption way via the cover case 200.

In addition, since the display unit 210 may be configured at any side of the cover case 200 (note that the application should not be limited to the design of the cover case 200 as shown in FIG. 2), even if the user is unable to see the monitor of the electronic device 300 (for example, the user covers the monitor of the electronic device 300 on the desk), the user may still see the display data received from the electronic device 300 via the display unit 210 of the cover case 200. In this manner, the practicality and variability of the cover case are greatly increased. The communication between the cover case and the electronic device are further discussed in the following paragraphs.

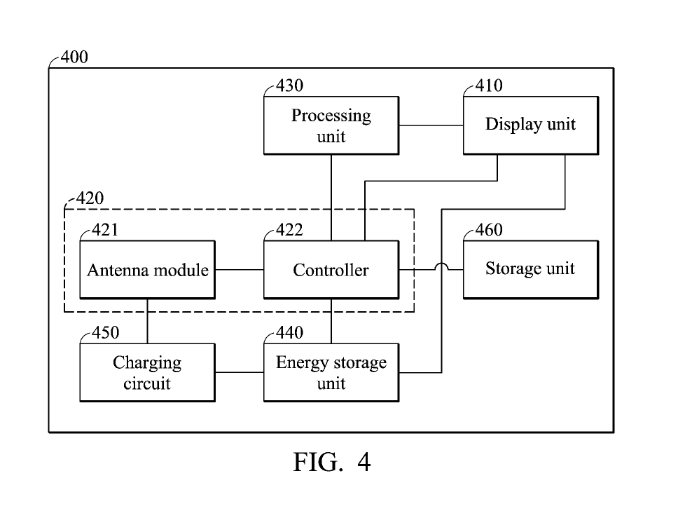

FIG. 4 shows a block diagram of a cover case according to an embodiment of the application. According to an embodiment of the application, the cover case 400 may comprise a display unit 410 (for example, the display device 210 shown in FIG. 2), a wireless communication module 420 (for example the wireless communication module 220 shown in FIG. 2), a processing unit 430 (for example, the processing unit 230 shown in FIG. 2), an energy storage unit 440 (for example, the battery device 240 as shown in FIG. 2), a charging circuit 450 and a storage unit 460. In the embodiment of the application, the wireless communication module of the cover case is preferably the Near Field Communication (NFC) module. However, note that the application should not be limited thereto.

The wireless communication module 420 may further comprise an antenna module 421, which may comprise one or more antennas, and a controller 422 controlling the transmission and reception of the antenna module 421. According to an embodiment of the application, the antenna module 421 may receive a wireless signal from the electronic device, where the wireless signal may be an electromagnetic signal and may comprise display data. The controller 422 may be coupled to the antenna module 421 for obtaining the display data according to the wireless signal. The display unit 410 may be coupled to the controller 422 and the processing unit 430 for displaying the display data. The energy storage unit 440 may be coupled to the controller 422 and the display unit 410. The charging circuit 450 may be coupled to the antenna module 421 and the energy storage unit 440 for converting the wireless signal received via the antenna module 421 into electricity and further storing the electricity to the energy storage unit 440. According to an embodiment of the application, the wireless communication module 420 may receive at least one wireless signal comprising electricity and the display data in compliance with the wireless predetermined communication protocol (for example, the NFC communication protocol) and store the display data in the storage unit 460 (when required). The processing unit 430 may be coupled to the wireless communication module 420 for obtaining the display data received from the electronic device and controlling the display unit 410 to display the display data. For example, the processing unit 430 may store or be pre-programmed of the software stacks supporting the predetermined wireless communication protocol and may communicate with the wireless communication module 420 in compliance with the predetermined wireless communication protocol. Note that in other embodiments of the application, the charging circuit 450 may be integrated in the controller 422, or the controller 422 and the processing unit 430 may be integrated together. Therefore, the application should not be limited to what is shown in FIG. 4.

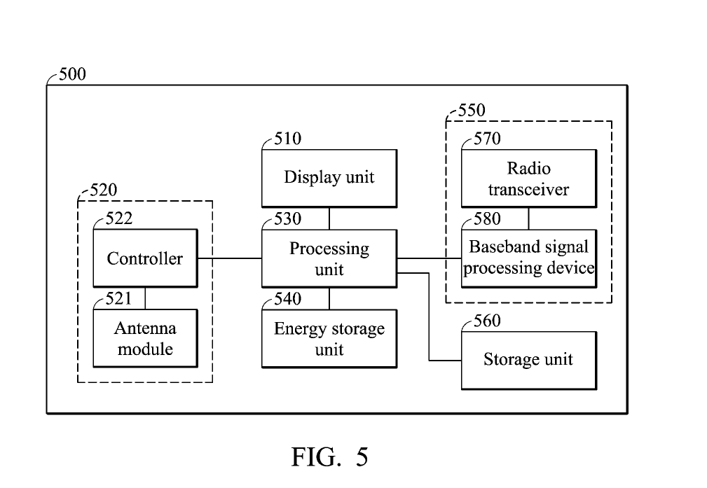

FIG. 5 shows a block diagram of an electronic device according to an embodiment of the application. According to an embodiment of the application, the electronic device 500 may at least comprise a display unit 510, a wireless communication module 520 (for example, the wireless communication module 320 as shown in FIG. 3) which comprises an antenna module 521 and a controller 522, a processing unit 530, an energy storage unit 540, a storage unit 560, and another wireless communication module which comprises a radio transceiver 570 and a baseband signal processing device 580. Note that in order to clarify the concept of the application, FIG. 5 presents a simplified block diagram, in which only the elements relevant to the application are shown. However, note that the application should not be limited to what is shown in FIG. 5.

The radio transceiver 570 and the baseband signal processing device 580 provide wireless communication services in compliance with a predetermined wireless communication protocol. The radio transceiver 570 may generate radio frequency (RF) signals and transmit the RF signals to and receive the RF signals from the air interface. The baseband signal processing device 580 may process baseband signals. The processing unit 530 may control operations of the display unit 510, the wireless communication module 520, the energy storage unit 540, the storage unit 560 and the wireless communication module 550, and may generate the display data. The wireless communication module 520 may comprise an antenna module 521 and a controller 522. The antenna module 521 may generate a wireless signal comprising the display data according to a control signal. The antenna module 521 may comprise one or more antennas. The controller 522 may be coupled to the antenna module 521 and the processing unit 530 and may generate the control signal according to the display data.

According to an embodiment of the application, when the wireless communication module equipped in the cover case is an NFC module, the wireless communication module 520 equipped in the electronic device is preferably an NFC module. The wireless communication module 520 may transmit at least one wireless signal comprising electricity and display data to the cover case in compliance with a predetermined wireless communication protocol (for example, the NFC communication protocol). The processing unit 530 may store or be pre-programmed of the software stacks supporting the predetermined communication protocol and may communicate with the wireless communication module 520 in compliance with the predetermined communication protocol. In addition, the wireless communication module 520 may be selected as a multiple-tag element. Therefore, the wireless communication module 520 may communicate with multiple devices at the same time, not being limited to the wireless communication module 420.

According to an embodiment of the application, when the cover case 400 attaches to the electronic device 500, the cover case 400 may transmit a wireless signal via the wireless communication module 420 to convey the identity information thereof to the electronic device 500 and register with the electronic device 500, such that the electronic device 500 can recognize the cover case 400. After registration, the electronic device 500 may change a software setting such that, when an event about which the electronic device 500 has to notify the user has occurred, the electronic device 500 may generate and transmit at least one wireless signal comprising the display data to the cover case 400. The event that the electronic device 500 has to notify the user may comprise but not limit to, a missed call notification, an unread message notification, a battery volume, a current time, a calendar reminder notification, a system update notification, or others.

By changing the software setting value, when an event about which the electronic device 500 has to notify the user has occurred, the electronic device 500 does not directly enter the idle mode or sleep mode after displaying the notification of the event on the display unit of the electronic device 500 (when required), but generates and transmits at least one wireless signal comprising the display data to the cover case 400 and then return to the idle mode or sleep mode for reducing the power consumption. In this manner, the display data may be displayed in a low power consumption way via display unit 410 of the cover case 400.

For example, when the electronic device 500 receives an incoming call, the electronic device 500 shows the incoming call notification on the monitor of the display unit 510 to facilitate the user to answer this call. When the user is unable to answer the incoming call on time, a missed call is generated. At this time, the electronic device 500 may generate a wireless signal comprising this missed call notification to the cover case 400 via the wireless communication module 520. When the wireless communication module 420 of the cover case receives the notification, the wireless communication module 420 stores the display information carried in the wireless signal in the storage unit 460 and issues an interrupt signal to the processing unit 430. After receiving the interrupt signal, the processing unit 430 may access the storage unit 460 so as to extract the missed call notification and control the display unit 410 to show the missed call notification. Note that in other embodiments of the application, the processing unit 430 may also directly access the storage unit 460 and determine whether the content stored in the storage unit 460 changes. In other words, there is no need to use the interrupt signal. The processing unit 430 may determine whether displaying the display data is required according to the content stored in the storage unit 460.

In another example, when an activity recorded in the calendar of the user is about to begin, the electronic device 500 may generate a calendar reminder notification first, so as to show the calendar reminder notification on the screen of the display unit 510 for notifying the user. Meanwhile, the electronic device 500 may also transmit a wireless signal comprising the calendar reminder notification to the cover case 400 via the wireless communication module 520. When the wireless communication module 420 of the cover case 400 receives the notification, the wireless communication module 420 stores the display information carried in the wireless signal in the storage unit 460 and issue an interrupt signal to the processing unit 430. After receiving the interrupt signal, the processing unit 430 may access the storage unit 460 so as to extract the calendar reminder notification and control the display unit 410 to show the calendar reminder notification. Note that in other embodiments of the application, the processing unit 430 may also directly access the storage unit 460 and determine whether the content stored in the storage unit 460 had changed.

Besides the embodiments discussed above, in other embodiments of the application, when the processing unit 530 does not trigger the display unit 510 to display the display data, the controller 522 generates the control signal according to the display data. When the processing unit 530 of the electronic device triggers the display unit 510 to display the display data, the processing unit 530 does not trigger the controller 522 to generate the control signal. In addition, besides the embodiments discussed above, in other embodiments of the application, the processing unit 530 may also generate the display data according to the data stored in the storage unit 560, and the controller 522 may generate the control signal according to the display data. In addition to the embodiments discussed above, in other embodiments of the application, when the antenna module 521 generates the wireless signal according to the control signal, the processing unit 530 may also disable the display unit 510.

According to an embodiment of the application, when the cover case attaches to the electronic device, the display unit of the electronic device may face a first direction and the display unit of the cover case may face a second direction, wherein the first direction and the second direction may be the same direction, different directions or inverse directions. For example, the display unit of the electronic device may be disposed on the surface of the electronic device, and the display unit of the cover case may be disposed at the back of the electronic device.

In addition, according to another embodiment of the application, the electricity may further be transmitted between the electronic device and the cover case via the wireless communication module, so as to provide the required electricity to the cover case. For example, when the electronic device 500 is coupled to a charger (not shown) for charging the energy storage unit 540, the electronic device 500 may transmit the electricity to the cover case 400 via the wireless communication module 520 and store the electricity in the energy storage unit 440 via the charging circuit 450.

As discussed above, since the wireless communication module of the cover case may support both the electricity transmission and signal transmission (that is, communicate with another device) at the same time, the cover case not only provides the functionality as a protecting shell, but also provides the additional information display functionality. Therefore, even if the user is unable to see the monitor of the electronic device, the user may still see the display data transmitted by the electronic device via the display unit of the cover case. In this manner, the practicality and variability of the cover case are greatly increased.

The above-described embodiments of the present application may be implemented in any of numerous ways. For example, the embodiments may be implemented using hardware, software or a combination thereof. It should be appreciated that any component or collection of components that perform the functions described above may be generically considered as one or more processors that control the above discussed function. The one or more processors may be implemented in numerous ways, such as with dedicated hardware, or with general purpose hardware that is programmed using microcode or software to perform the functions recited above.

While the application has been described by way of example and in terms of preferred embodiment, it is to be understood that the application is not limited thereto. Those who are skilled in this technology may still make various alterations and modifications without departing from the scope and spirit of this application. Therefore, the scope of the present application shall be defined and protected by the following claims and their equivalents.

What is claimed is:

1. A cover case suitable for an electronic device, the cover case being detachably attached to the electronic device, comprising:
an antenna module, receiving a wireless signal from the electronic device, the wireless signal comprising display data;
a controller, coupled to the antenna module, the controller obtaining the display data from to the wireless signal;
a display unit, coupled to the controller, for displaying the display data;
an energy storage unit, coupled to the controller and the display unit; and
a charging circuit, coupled to the antenna module and the energy storage unit, the charging circuit converting the wireless signal into electricity via the antenna module and storing the electricity in the energy storage unit.

2. The cover case as claimed in claim 1, wherein the controller is a near field communication controller.

3. The cover case as claimed in claim 1, wherein the cover case comprises at least three side walls and a recess defined by the side walls, the electronic device is configured in the recess, and the display unit is configured in any side wall of the cover case.

4. The cover case as claimed in claim 1, wherein the display unit is a bi-stable display device.

5. The cover case as claimed in claim 1, wherein the charging circuit is integrated in the controller.

6. The cover case as claimed in claim 1, wherein the electronic device comprises a first surface, a side wall and a back, the side wall is connected to the back and the first surface, the side wall comprises four corners, a display unit is configured on the first surface, and the cover case attaches to the back and the four corners.

7. An electronic system, comprising:
an electronic device, comprising:
a processing unit, for generating display data;
a first antenna module, for generating a first wireless signal according to a control signal, the first wireless signal comprising the display data;
a first controller, coupled to the first antenna module and the processing unit, the first controller generating the control signal according to the display data; and
a first display unit, coupled to the processing unit; and
a cover case, detachably attached to the electronic device, comprising:
a second antenna module, receiving the first wireless signal generated by the electronic device;
a second controller, coupled to the second antenna module, the second controller obtaining the display data from to the received first wireless signal;
a second display unit, coupled to the second controller for displaying the display data;
an energy storage unit, coupled to the second controller and the second display unit; and
a charging circuit, coupled to the second antenna module and the energy storage unit, the charging circuit converting the first wireless signal into electricity via the second antenna module and storing the electricity in the energy storage unit.

8. The electronic system as claimed in claim 7, wherein the first controller and the second controller are near field communication controllers.

9. The electronic system as claimed in claim 8, wherein when the processing unit does not trigger the first display unit to display the display data, the first controller generates the control signal according to the display data.

10. The electronic system as claimed in claim 8, wherein when the processing unit triggers the first display unit to display the display data, the processing unit does not trigger the first controller to generate the control signal.

11. The electronic system as claimed in claim 8, wherein the electronic device further comprises a wireless communication module, coupled to the processing unit, for receiving a second wireless signal, and when the processing unit generates the display data according to the second wireless signal, the first controller generates the control signal according to the display data.

12. The electronic system as claimed in claim 8, wherein the electronic device further comprises a storage unit, coupled to the processing unit, for storing data, and when the processing unit generates the display data according to the data, the first controller generates the control signal according to the display data.

13. The electronic system as claimed in claim 8, wherein the cover case comprises at least three side walls and a recess defined by the side walls, the electronic device is configured in the recess, and the display unit is configured in any side wall of the cover case.

14. The electronic system as claimed in claim 8, wherein the electronic device comprises a first surface, a side wall and a back, the side wall is connected to the back and the first surface, the side wall comprises four corners, the first display unit is configured on the first surface, and the cover case attaches to the back and the four corners.

15. The electronic system as claimed in claim 8, wherein the first display unit faces a first direction and the second display unit faces a second direction.

16. The electronic system as claimed in claim 8, wherein the first direction is inverse to the second direction.

17. The electronic system as claimed in claim 8, wherein the first direction is different from the second direction.

18. The electronic system as claimed in claim 8, wherein the second display unit is a bi-stable display device.

19. The electronic system as claimed in claim 8, wherein after the first antenna module generates the first wireless signal according to the control signal, and the processing unit disables the first display unit.
